(19) United States
(12) Patent Application Publication
(10) Pub. No.: US 2020/0023863 A1
(43) Pub. Date: Jan. 23, 2020

(54) CONCENTRATION DEGREE DETERMINATION DEVICE, CONCENTRATION DEGREE DETERMINATION METHOD, AND PROGRAM FOR DETERMINING CONCENTRATION DEGREE

(71) Applicant: OMRON Corporation, Kyoto-shi, KYOTO (JP)

(72) Inventors: Tomoyoshi AIZAWA, Kyoto-shi (JP); Tomohiro YABUUCHI, Kyoto-shi (JP); Madoka WATANABE, Kyoto-shi (JP)

(73) Assignee: OMRON Corporation, Kyoto-shi, KYOTO (JP)

(21) Appl. No.: 16/334,851

(22) PCT Filed: Oct. 25, 2017
(86) PCT No.: PCT/JP2017/038571

§ 371 Date: Mar. 20, 2019

(30) Foreign Application Priority Data
Mar. 14, 2017 (JP) 2017-048169

(51) Int. Cl. B60W 50/12; B60W 40/08; G06K 9/00; G05D 1/00

(52) U.S. Cl. CPC B60W 50/12; B60W 40/08; B60W 2050/0071; G05D 1/0061; G06K 9/00845

(57) ABSTRACT

A concentration degree determination device includes: a monitoring data acquisition unit configured to acquire monitoring data from a sensor that monitors a driver of a vehicle; a concentration degree estimator configured to estimate a driving concentration degree of the driver from the monitoring data; a reference comparator configured to compare the driving concentration degree to a first reference when a driving mode of the vehicle is an automatic driving mode, and to compare the driving concentration degree to a second reference when the driving mode is a manual driving mode; and a signal output unit configured to output an instruction signal instructing performance of support to the driver when the driving mode is the automatic driving mode while the driving concentration degree does not satisfy the first reference, or when the driving mode is the manual driving mode while the driving concentration degree does not satisfy the second reference.

### TECHNICAL FIELD

The present invention relates to a concentration degree determination device that determines a concentration degree of a driver of a vehicle, a concentration degree determination method, and a program for determining the concentration degree.

### BACKGROUND ART

In recent years, in addition to a manual driving mode in which a vehicle is caused to run based on a driving operation of a driver, an automatic driving mode in which the vehicle is caused to run along a previously-set route regardless of the driving operation of the driver has been developed as an driving mode of a vehicle.

A technique of determining whether the driver can perform manual driving has also been developed (see Japanese Unexamined Patent Publication No. 10-309960).

### SUMMARY OF THE INVENTION

Although drivers are required to secure driving safety, driving concentration degree required for the driver varies depending on a situation in which the driver is placed. The driving safety is maintained when the vehicle constantly monitors the driving concentration degree of the driver by a strict reference and issues a warning when the driving concentration degree falls below the reference. However, the vehicle frequently issues an alarm depending on the situation in which the driver is placed. In this case, driving comfort of the driver is impaired.

The present invention has been made in view of the above circumstances, and an object of the present invention is to provide a concentration degree determination device, a concentration degree determination method, and a program for determining the concentration degree for allowing both the driving safety and the driving comfort to be considered.

In order to solve the above problem, according to a first aspect of the present invention, a concentration degree determination device includes: a monitoring data acquisition unit configured to acquire monitoring data from a sensor that monitors a driver of a vehicle; a concentration degree estimator configured to estimate a driving concentration degree of the driver from the monitoring data; a reference comparator configured to compare the driving concentration degree to a first reference when a driving mode of the vehicle is an automatic driving mode, and to compare the driving concentration degree to a second reference different from the first reference when the driving mode is a manual driving mode; and a signal output unit configured to output an instruction signal instructing performance of support to the driver when the driving mode is the automatic driving mode while the driving concentration degree does not satisfy the first reference, or when the driving mode is the manual driving mode while the driving concentration degree does not satisfy the second reference.

According to a second aspect of the present invention, in the concentration degree determination device of the first aspect, the second reference is such a reference that the driving concentration degree higher than the first reference is required for the driver.

According to a third aspect of the present invention, in the concentration degree determination device of the first aspect, the second reference is such a reference that a predetermined driving concentration degree is required for the driver in timing different from the first reference.

According to a fourth aspect of the present invention, in the concentration degree determination device of the first aspect, the second reference is such a reference that continuation of a predetermined driving concentration degree is required for the driver over a period longer than the first reference.

According to a fifth aspect of the present invention, in the concentration degree determination device of the first aspect, the concentration degree estimator estimates the driving concentration degree with looking aside of the driver as an index.

According to a sixth aspect of the present invention, a concentration degree determination method includes: a monitoring data acquisition step of acquiring monitoring data from a sensor that monitors a driver of a vehicle; a concentration degree estimating step of estimating a driving concentration degree of the driver from the monitoring data; a reference comparing step of comparing the driving concentration degree to a first reference when a driving mode of the vehicle is an automatic driving mode, and of comparing the driving concentration degree to a second reference different from the first reference when the driving mode is a manual driving mode; and a signal output step of outputting an instruction signal instructing performance of support to the driver when the driving mode is the automatic driving mode while the driving concentration degree does not satisfy the first reference, or when the driving mode is the manual driving mode while the driving concentration degree does not satisfy the second reference.

According to a seventh aspect of the present invention, a program for determining concentration degree, the program causes a computer to execute processing of each unit included in the concentration degree determination device according to any one of the first to fifth aspects.

According to the first aspect of the present invention, the concentration degree determination device can require the driver to secure the driving concentration degree suitable for each of the automatic driving mode and the manual driving mode. Consequently, the driver can maintain the state of concentrating on the driving regardless of the driving mode. Thus, the driving safety is maintained regardless of the situation in which the driver is placed.

Additionally, according to the first aspect, even if the state of the driver is the same between the manual driving mode and the automatic driving mode, the concentration degree determination device outputs the instruction signal in the manual driving mode, but the concentration degree determination device does not output the instruction signal in the automatic driving mode. For this reason, the concentration degree determination device can reduce the output of the excessive instruction signal in the automatic driving mode. Consequently, the driver does not receive the excessive warning particularly in the automatic driving mode, so that the driver can comfortably maintain the state of concentrating on the driving regardless of the driving mode. Thus, the driving comfort is maintained regardless of the situation in which the driver is placed.

That is, according to the first aspect, the concentration degree determination device can consider both the driving safety and the driving comfort.

According to the second aspect of the present invention, in the case of the manual driving mode, the concentration degree determination device can require the driver to secure the driving concentration degree higher than that of the automatic driving mode. Consequently, in the case of the manual driving mode, the driver can maintain the state of further concentrating on the driving as compared with the case of the automatic driving mode. Additionally, the driver does not receive an excessive warning, particularly in the automatic driving mode.

According to the third aspect of the present invention, the concentration degree determination device can determine the driving concentration degree in proper timing corresponding to the driving mode. The concentration degree determination device does not output the instruction signal in timing at which the determination of the driving concentration degree can be omitted. Consequently, the driver can maintain the state of concentrating on the driving according to the driving mode. Additionally, the driver does not receive an excessive warning, particularly in the automatic driving mode.

According to the fourth aspect of the present invention, in the case of the manual driving mode, the concentration degree determination device can require the driver to continuously secure the predetermined driving concentration degree longer than that of the automatic driving mode. Consequently, in the case of the manual driving mode, the driver can maintain the state of further concentrating on the driving as compared with the case of the automatic driving mode. Additionally, the driver does not receive an excessive warning, particularly in the automatic driving mode.

According to the fifth aspect of the present invention, the concentration degree determination device can monitor whether the driver is in the state suitable for the driving using the index as looking aside that has the large influence on the driving safety regardless of the driving mode. Consequently, the driver can maintain the state of further concentrating on the driving regardless of the driving mode.

According to the sixth aspect of the present invention, the concentration degree determination method can obtain the same effect as the first aspect. That is, the concentration degree determination method can consider both the driving safety and the driving comfort.

According to the seventh aspect of the present invention, the program for determining the concentration degree can obtain the same effect as the first aspect. That is, the program for determining the concentration degree can consider both the driving safety and the driving comfort.

### BRIEF DESCRIPTION OF THE DRAWINGS

FIG. 1 is a view illustrating an overall configuration of a vehicle including a concentration degree determination device according to an embodiment of the present invention.

FIG. 2 is a block diagram illustrating a configuration of the concentration degree determination device of the embodiment of the present invention.

FIG. 3 is a block diagram illustrating a configuration of a state detector of the embodiment of the present invention.

FIG. 4 is a flowchart illustrating a procedure of concentration degree determination made by the concentration degree determination device in FIG. 2.

### MODE FOR CARRYING OUT THE INVENTION

An embodiment of the present invention will be described below with reference to the drawings.

### (Embodiment)

### (Configuration)

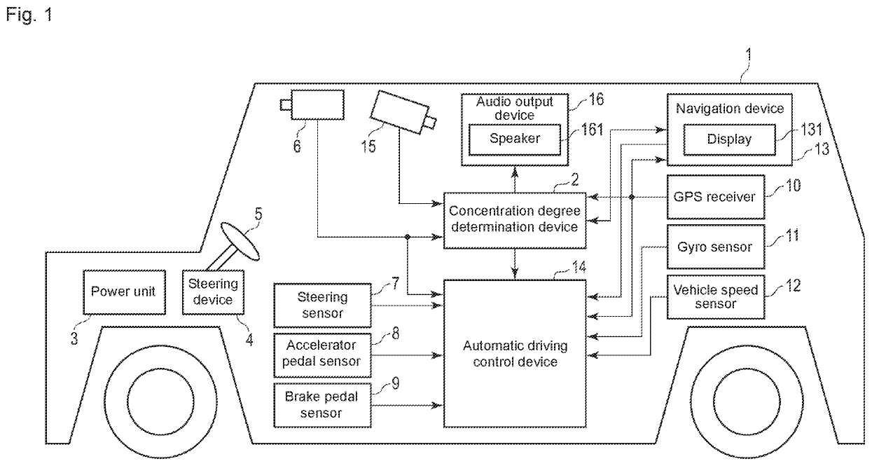

FIG. 1 is a view illustrating an overall configuration of a vehicle 1 including a concentration degree determination device 2 of an embodiment of the present invention. The concentration degree determination device 2 is mounted on the vehicle 1 such as a passenger car. A configuration of the concentration degree determination device 2 will be described later. For example, the vehicle 1 may be any one of a car, a bus, a truck, a train, and the like, or other vehicles on which a driver rides.

The vehicle 1 includes a power unit 3 including a power source and a speed change device and a steering device 4 equipped with a steering wheel 5 as basic equipment, and has a manual driving mode and an automatic driving mode as a driving mode. An engine, a motor, or both are used as the power source.

For example, the manual driving mode is a mode in which the vehicle 1 is mainly caused to run by a manual driving operation of the driver. For example, the manual driving mode includes an operating mode in which the vehicle 1 is caused to run based only on the driving operation of the driver and an operating mode in which driving operation support control to support the driving operation of the driver is performed while the driving operation of the driver is mainly performed.

For example, the driving operation support control assists steering torque such that steering of the driver becomes a proper steering amount based on a curvature of a curve when the vehicle 1 is running on the curve. The driving operation support control also includes control to support an accelerator operation (for example, an operation of an accelerator pedal) or a brake operation (for example, an operation of a brake pedal) of the driver, manual steering (manual driving of the steering), and manual speed adjustment (manual driving of speed adjustment). In the manual steering, the driver mainly operates the steering wheel 5 to steer the vehicle 1. In the manual speed adjustment, the speed of the vehicle 1 is adjusted mainly by accelerator operation or brake operation by the driver.

The driving operation support control does not include control to forcibly intervene the driving operation of the driver to cause the vehicle 1 to run automatically. That is, the manual driving mode includes control to reflect the driving operation of the driver in the running of the vehicle 1 within a previously-set allowable range, but does not include control to forcibly intervene the running of the vehicle 1 under a certain condition (for example, lane departure of the vehicle 1).

On the other hand, for example, the automatic driving mode is a mode in which a driving state in which the vehicle 1 is cause to run automatically along a running road of the vehicle 1 is performed. For example, the automatic driving mode includes a driving state in which the driver causes the vehicle 1 to run automatically toward a previously-set destination without performing the driving operation. In the automatic driving mode, the whole control of the vehicle 1 is not necessarily automatically performed. The automatic driving mode also includes a driving state in which the driving operation of the driver is reflected in the running of the vehicle 1 within a previously-set allowable range. That is, the automatic driving mode includes control to reflect the driving operation of the driver in the running of the vehicle 1 within the previously-set allowable range, and to forcibly intervene the running of the vehicle 1 under a certain condition.

The vehicle 1 further includes an external camera 6, a steering sensor 7, an accelerator pedal sensor 8, a brake pedal sensor 9, a GPS receiver 10, a gyro sensor 11, a vehicle speed sensor 12, a navigation device 13, an automatic driving control device 14, a driver camera 15, and an audio output device 16.

The external camera 6 is installed at any position of the vehicle 1 so as to capture an image of an outside of the vehicle 1. Although one external camera 6 is illustrated in FIG. 1, the vehicle 1 may include a plurality of external cameras that capture images in different directions. The external camera 6 continuously captures the image of a running environment in a vicinity of the vehicle 1. The external camera 6 is activated in response to start of driving of the vehicle 1, and continuously captures the image of the outside of the vehicle 1. The external camera 6 outputs the captured image (hereinafter, also referred to as “external image data”) to the concentration degree determination device 2 and the automatic driving control device 14.

The steering sensor 7 detects a steering angle. The steering sensor 7 outputs a detection result to the automatic driving control device 14. The accelerator pedal sensor 8 detects an operation amount of the accelerator pedal. The accelerator pedal sensor 8 outputs the detection result to the automatic driving control device 14. The brake pedal sensor 9 detects the operation amount of the brake pedal. The brake pedal sensor 9 outputs the detection result to the automatic driving control device 14. The GPS receiver 10 receives current position information about the vehicle 1. The GPS receiver 10 outputs the current position information to the concentration degree determination device 2, the navigation device 13, and the automatic driving control device 14. The gyro sensor 11 detects a behavior of the vehicle 1. The gyro sensor 11 outputs the detection result to the automatic driving control device 14. The vehicle speed sensor 12 detects speed of the vehicle 1. The vehicle speed sensor 12 outputs the detection result to the automatic driving control device 14.

The navigation device 13 is an example of a video display device including a display 131 that displays video. The navigation device 13 stores map information. The navigation device 13 extracts route information from a current position to a destination using information about the destination input by the driver or the like, the map information, and the current position information from the GPS receiver 10. The navigation device 13 displays the route information on the display 131. The navigation device 13 can also display information except for the route information on the display 131. The navigation device 13 outputs the route information to the concentration degree determination device 2 and the automatic driving control device 14.

The route information may include not only information about a route from the current position to the destination but also information about a road environment from the current position to the destination. Some examples of the information about the road environment will be described. The information about the road environment may include information about a type of road through which the vehicle 1 passes from the current position to the destination. For example, the type of the road is divided into a road on which passage of a person is restricted and a road on which the passage of the person is not restricted. For example, the road on which the passage of the person is restricted is an expressway. The expressway can also be referred to as a superhighway. For example, the road on which the passage of the person is not restricted is an ordinary road.

The information about the road environment may include information about a speed limit of the road through which the vehicle 1 passes from the current position to the destination. The information about the road environment may include position information about an installed object on the road through which the vehicle 1 passes from the current position to the destination. For example, the installed object is a sign, or may be an object installed on the road. The information about the road environment may include the position information about the building in the vicinity of the road through which the vehicle 1 passes from the current position to the destination. The route information may include information except for the above example as information about the road environment.

The configuration of the automatic driving control device 14 will be described. The automatic driving control device 14 automatically controls the running of the vehicle 1 when the driving mode is the automatic driving mode. The automatic driving control device 14 acquires the external image data from the external camera 6, the detection result from the steering sensor 7, the detection result from the accelerator pedal sensor 8, the detection result from the brake pedal sensor 9, the current position information from the GPS receiver 10, the detection result from the gyro sensor 11, the detection result from the vehicle speed sensor 12, and the route information from the navigation device 13. For example, the automatic driving control device 14 automatically controls the running of the vehicle 1 based on these pieces of information and traffic information acquired by road-to-vehicle communication.

For example, automatic control includes automatic steering (automatic driving of the steering) and automatic speed adjustment (automatic driving of the speed). The automatic steering is a driving state in which the steering device 4 is automatically controlled. The automatic steering includes a lane keeping assist system (LKAS). The LKAS automatically controls the steering device 4 such that the vehicle 1 does not deviate from a driving lane, for example, even if the driver does not perform the steering operation. Even during the performance of the LKAS, the steering operation of the driver may be reflected on the steering of the vehicle 1 within a range (allowable range) in which the vehicle 1 does not deviate from the driving lane. The automatic steering is not limited to the LKAS.

The automatic speed adjustment is a driving state in which the speed of the vehicle 1 is automatically controlled. The automatic speed adjustment includes adaptive cruise control (ACC). For example, the ACC performs constant speed control causing the vehicle 1 to run at a constant speed and at a previously-set speed in the case that a preceding vehicle does not exist in front of the vehicle 1, and the ACC performs follow-up control adjusting the vehicle speed of the vehicle 1 according to an inter-vehicle distance to the preceding vehicle in the case that the preceding vehicle exists in front of the vehicle 1. The automatic driving control device 14 decelerates the vehicle 1 in response to the brake operation (for example, the operation of the brake pedal) of the driver even while the ACC is currently performed. Even if the ACC is currently performed, the automatic driving control device 14 can accelerate the vehicle 1 in response to the accelerator operation (for example, the operation of the accelerator pedal) of the driver up to a previously-set maximum permissible speed (for example, a legally-defined maximum speed on the road on which the vehicle is running). The automatic speed adjustment is not limited to not only the ACC but also cruise control (CC: constant speed control).

The configuration of the driver camera 15 will be described.

For example, the driver camera 15 is installed at a position, such as on a dashboard, which faces a front of the driver. The driver camera 15 is an example of a sensor that monitors the driver. The driver camera 15 is activated in response to the start of the driving of the vehicle 1, and continuously captures an image of a predetermined range including a face of the driver. The driver camera 15 outputs the captured image (hereinafter, referred to as driver image data) to the concentration degree determination device 2. The driver image data is an example of monitoring data used to detect the state of the driver. For example, the state of the driver includes at least one of indices such as front gazing of a driver, sleepiness, looking aside, putting-on and taking-off of clothes, a telephone operation, leaning against a window side or an armrest, driving interference by a passenger or a pet, onset of a disease, back-facing, lying face down, eating and drinking, smoking, dizziness, an abnormal behavior, a car navigation or audio operation, putting-on and taking-off of glasses or sunglasses, image capturing, and an object recognition degree. The object recognition degree is an index how much the driver recognizes an object (for example, visually), and is a degree to which the driver consciously confirms (for example, visually) an object. The state of the driver may include an index except for the indices exemplified here.

The audio output device 16 includes a speaker 161. The audio output device 16 outputs various pieces of information by sound.

The configuration of the concentration degree determination device 2 will be described. The concentration degree determination device 2 estimates a driving concentration degree of the driver based on the state of the driver and determines whether the driver is suitable for driving the vehicle 1. The driving concentration degree is a degree to which the driver is suitable for the driving of the vehicle 1. With increasing driving concentration degree, the driver becomes more suitable for the driving of the vehicle 1. On the other hand, with decreasing driving concentration degree, the driver becomes under a condition that the driver is not suitable for the driving of the vehicle 1. Even if the driving mode is the automatic driving mode, the concentration degree determination device 2 is configured to perform the support to the driver depending on the driving concentration degree. The support to the driver by the concentration degree determination device 2 will be described later.

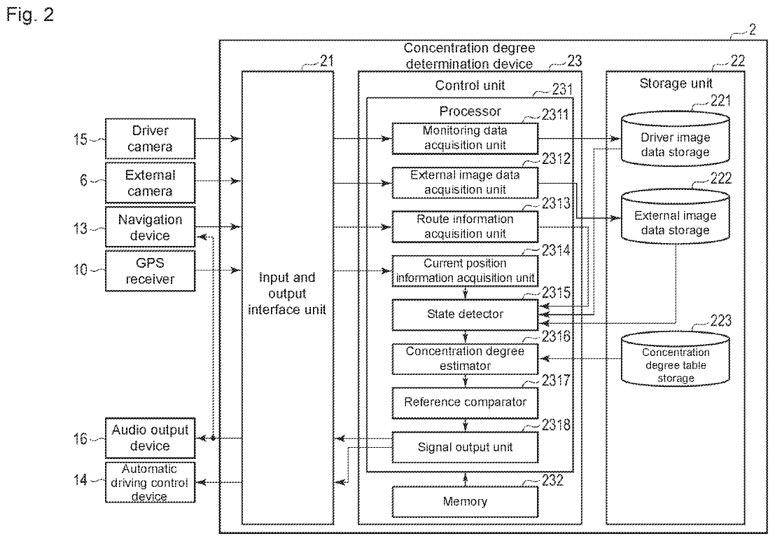

FIG. 2 is a block diagram illustrating the configuration of the concentration degree determination device 2 as an example. The concentration degree determination device 2 includes an input and output interface unit 21, a storage unit 22, and a control unit 23.

The input and output interface unit 21 connects each of the external camera 6, the GPS receiver 10, the navigation device 13, the automatic driving control device 14, the driver camera 15, and the audio output device 16 to the control unit 23.

The configuration of the storage unit 22 will be described. The storage unit 22 is a nonvolatile memory, such as a solid state drive (SSD) and a hard disk drive (HDD), in which writing and reading can be performed at any time. The storage unit 22 includes a driver image data storage 221, an external image data storage 222, and a concentration degree table storage 223.

The driver image data storage 221 stores the driver image data that is acquired from the driver camera 15 by the control unit 23. The external image data storage 222 stores the external image data that is acquired from the external camera 6 by the control unit 23.

The concentration degree table storage 223 stores a concentration degree table that is used by the control unit 23 to estimate the driving concentration degree. For each index, the concentration degree table correlates the state of the driver while dividing the state of the driver into a plurality of degrees according to the driving concentration degree. For example, the plurality of degrees are divided into three levels of a level 1, a level 2, and a level 3. However, the present invention is not limited to this configuration. At this point, an example in which the driving concentration degree is set lower as the level number increases will be described. However, the present invention is not limited to this example. The driving concentration degree may be set higher as the level number increases.

Information managed in the concentration degree table will be described by taking looking aside as an example. The concentration degree table correlates the state of the driver with the level 1, the level 2, and the level 3 with respect to the looking aside as an index. For example, the level 1 is correlated with the state of the driver who looks at a direction inclined at an angle within the range greater than or equal to 0 degrees and less than a first angle with respect to a traveling direction of the vehicle 1. That is, the level 1 is a state in which the driver is not looking aside but has the high driving concentration degree. For example, the level 2 is correlated with the state of the driver who looks at the direction inclined at an angle within a range greater than or equal to the first angle and less than a second angle with respect to the traveling direction of the vehicle 1. That is, the level 2 is a state, in which the driver is slightly looking aside and the driving concentration degree is lower than that of the level 1. For example, the level 3 is correlated with the state of the driver who looks at the direction inclined at an angle within the range greater than or equal to the second angle with respect to the traveling direction of the vehicle 1. That is, the level 3 is a state, in which the driver is looking aside and the driving concentration degree is lower than that of the level 2. In this case, the information managed in the concentration degree table is described by taking the looking aside as an example. The same holds true for other indices.

The configuration of the control unit 23 will be described. The control unit 23 includes a processor 231 and a memory 232. For example, the processor 231 is a central processing unit (CPU) constituting a computer. The configuration of each unit of the processor 231 will be described later. Although one processor 231 is illustrated in FIG. 2, the control unit 23 may include at least one processor. The memory 232 is provided with a program causing the processor 231 to function as processing of each unit of the processor 231. The program can also be referred to as an instruction to operate the processor 231. The program is stored in the storage unit 22, and read from the storage unit 22 to the memory 232. The program of the memory 232 is read by the processor 231. One embodiment may be implemented by the program.

The configuration of each unit of the processor 231 will be described. The processor 231 includes a monitoring data acquisition unit 2311, an external image data acquisition unit 2312, a route information acquisition unit 2313, a current position information acquisition unit 2314, a state detector 2315, a concentration degree estimator 2316, a reference comparator 2317, and a signal output unit 2318. Each unit may be distributed to at least one processor.

The monitoring data acquisition unit 2311 acquires the driver image data from the driver camera 15 through the input and output interface unit 21. The monitoring data acquisition unit 2311 stores the driver image data in the driver image data storage 221. The external image data acquisition unit 2312 acquires the external image data from the external camera 6 through the input and output interface unit 21. The external image data acquisition unit 2312 stores the external image data in the external image data storage 222.

The route information acquisition unit 2313 acquires the route information from the navigation device 13 through the input and output interface unit 21. The route information acquisition unit 2313 outputs the route information to the state detector 2315. The current position information acquisition unit 2314 acquires the current position information from the GPS receiver 10 through the input and output interface unit 21. The current position information acquisition unit 2314 outputs the current position information to the state detector 2315.

The state detector 2315 detects the state of the driver from the driver image data stored in the driver image data storage 221. In addition to the driver image data, the state detector 2315 may detect the object recognition degree as the state of the driver using at least one of the external image data, the route information, and the current position information. A detection example of the state of the driver by the state detector 2315 will be described later. The state detector 2315 may acquire the driver image data from the monitoring data acquisition unit 2311 with no use of the driver image data storage 221. In this case, the storage unit 22 may not include the driver image data storage 221. The state detector 2315 outputs the state of the driver to the concentration degree estimator 2316.

The concentration degree estimator 2316 estimates the driving concentration degree of the driver based on the state of the driver detected by the state detector 2315. The state of the driver is detected from the driver image data as described above, so that the concentration degree estimator 2316 can also estimate the driving concentration degree of the driver from the driver image data. The concentration degree estimator 2316 estimates the driving concentration degree corresponding to each of at least one index included in the state of the driver. For example, the concentration degree estimator 2316 estimates the driving concentration degree using the sleepiness as an index, and also estimates the driving concentration degree with the looking aside as an index. For example, the concentration degree estimator 2316 may estimate one driving concentration degree by comprehensively determining the plurality of indices included in the state of the driver.

In one example, the concentration degree estimator 2316 can estimate the driving concentration degree using a numerical value such as a ratio. The numerical value estimated by the concentration degree estimator 2316 may increase with increasing driving concentration degree, or decrease with increasing driving concentration degree.

In another example, the concentration degree estimator 2316 can refer to the concentration degree table stored in the concentration degree table storage 223, and estimate the level of the driving concentration degree corresponding to the state of the driver from the plurality of levels. In the case that the concentration degree estimator 2316 estimates the driving concentration degree using the numerical value, the storage unit 22 may not include the concentration degree table storage 223.

The driving concentration degree may be estimated by the concentration degree estimator 2316 using an artificial intelligence (AI) function such as machine learning and deep learning. In this case, for example, the concentration degree estimator 2316 can accurately estimate the state of the driver by utilizing the past estimation result in the estimation of the current driving concentration degree.

The reference comparator 2317 compares the driving concentration degree estimated by the concentration degree estimator 2316 to the reference. The reference comparator 2317 compares the driving concentration degree to a first reference in the case that the driving mode of the vehicle 1 is the automatic driving mode. The first reference is a reference determining the driving concentration degree suitable for the automatic driving mode. On the other hand, in the case that the driving mode is the manual driving mode, the reference comparator 2317 compares the driving concentration degree to a second reference different from the driving concentration degree. The second reference is a reference determining the driving concentration degree suitable for the manual driving mode. In one example, the second reference may be such a reference that the driving concentration degree higher than the first reference is required for the driver. In this case, the second reference can also be said to be a stricter reference for the driving concentration degree than the first reference. In another example, the second reference may be such a reference that a predetermined driving concentration degree is required for the driver in timing different from the first reference. In still another example, the second reference may be such a reference that continuation of the predetermined driving concentration degree is required for the driver over a period longer than the first reference. The second reference may be different from the first reference as described above, but is not limited to the above examples. The first and second references may be arbitrarily changeable. In the case that the concentration degree estimator 2316 estimates the driving concentration degree with respect to each of the plurality of indices, the reference comparator 2317 may compare the driving concentration degree with respect to each of the plurality of indices to the reference. The reference comparator 2317 outputs the comparison result to the signal output unit 2318.

Comparison between the driving concentration degree by the reference comparator 2317 and the reference will be described by taking an example in which the second reference is such a reference that the driving concentration degree higher than the first reference is required for the driver. In this example, the reference comparator 2317 compares the driving concentration degree estimated by the concentration degree estimator 2316 to a first reference value or a first reference level, which becomes the first reference. When the driving concentration degree is greater than or equal to the first reference value or the first reference level, the reference comparator 2317 determines that the driving concentration degree satisfies the first reference.

Similarly, the reference comparator 2317 compares the driving concentration degree estimated by the concentration degree estimator 2316 to the second reference value or the second reference level, which becomes the second reference. When the driving concentration degree is greater than or equal to the second reference value or the second reference level, the reference comparator 2317 determines that the driving concentration degree satisfies the second reference.

The comparison between the driving concentration degree estimated by the reference comparator 2317 using the numerical value and the reference value will be described as an example. The case that the numerical value estimated by the concentration degree estimator 2316 increases with increasing driving concentration degree will be described below. The first reference value is a numerical value A, and the second reference value is a numerical value B larger than the numerical value A. The second reference value can be said that the driving concentration degree required for the driver is higher or stricter than the first reference value. When the numerical value estimated by the concentration degree estimator 2316 is smaller than the numerical value A that is the first reference value, the reference comparator 2317 determines that the driving concentration degree estimated by the concentration degree estimator 2316 is lower than the first reference value. Similarly, when the numerical value estimated by the concentration degree estimator 2316 is smaller than the numerical value B that is the second reference value, the reference comparator 2317 determines that the driving concentration degree estimated by the concentration degree estimator 2316 is lower than the second reference value.

The case that the numerical value estimated by the concentration degree estimator 2316 decreases with increasing driving concentration degree will be described below. The first reference value is a numerical value C, and the second reference value is a numerical value D smaller than the numerical value C. The second reference value can be said that the driving concentration degree required for the driver is higher or stricter than the first reference value. When the numerical value estimated by the concentration degree estimator 2316 is larger than the numerical value C that is the first reference value, the reference comparator 2317 determines that the driving concentration degree estimated by the concentration degree estimator 2316 is lower than the first reference value. Similarly, when the numerical value estimated by the concentration degree estimator 2316 is larger than the numerical value D that is the second reference value, the reference comparator 2317 determines that the driving concentration degree estimated by the concentration degree estimator 2316 is lower than the second reference value.

The comparison between the driving concentration degree estimated at the level by the reference comparator 2317 and the reference value will be described as another example. It is assumed that the first reference level is a level E extracted from a plurality of levels, and that the second reference level is a level F extracted from the plurality of levels. The level F that becomes the second reference level is higher or stricter than the level E at which the driving concentration degree required for the driver becomes the first reference level. In the case that the driving concentration degree lower than the level E that is the first reference level is assigned to the level estimated by the concentration degree estimator 2316, the reference comparator 2317 determines that the driving concentration degree estimated by the concentration degree estimator 2316 is lower than the first reference level. Similarly, in the case that the driving concentration degree lower than the level F that is the second reference level is assigned to the level estimated by the concentration degree estimator 2316, the reference comparator 2317 determines that the driving concentration degree estimated by the concentration degree estimator 2316 is lower than the second reference level.

An example in which the concentration degree table correlates the state of the driver with each index while dividing the state of the driver into three levels of the level 1, the level 2, and the level 3 will specifically be described. For example, the first reference level is set to the level 2, and the second reference level is set to the level 1 higher or stricter than the level 2. The reference comparator 2317 determines that the level 3 estimated by the concentration degree estimator 2316 is lower than the level 2 that is the first reference level. On the other hand, the reference comparator 2317 determines that the level 1 or level 2 estimated by the concentration degree estimator 2316 is not lower than the level 2 that is the first reference level. Similarly, the reference comparator 2317 determines that the level 2 or level 3 estimated by the concentration degree estimator 2316 is lower than the level 1 that is the second reference level. On the other hand, the reference comparator 2317 determines that the level 1 estimated by the concentration degree estimator 2316 is not lower than the level 1 that is the first reference level.

The signal output unit 2318 outputs a signal to each unit through the input and output interface unit 21. Examples of some signals output from the signal output unit 2318 will be described below.

Based on the comparison result from the reference comparator 2317, the signal output unit 2318 determines whether to output an instruction signal instructing the performance of the support to the driver to a support providing device. When the driving mode is the automatic driving mode, and when the driving concentration degree estimated by the concentration degree estimator 2316 does not satisfy the first reference, the signal output unit 2318 outputs the instruction signal. On the other hand, when the driving mode is the manual driving mode, and when the driving concentration degree estimated by the concentration degree estimator 2316 does not satisfy the second reference, the signal output unit 2318 outputs the instruction signal. Upon receiving the instruction signal from the signal output unit 2318, the support providing device performs predetermined support to the driver. For example, the support providing device is the navigation device 13 or the audio output device 16.

Based on the instruction signal, the navigation device 13 displays a warning giving attention to the driver on the display 131 as an image or video. Based on the instruction signal, the audio output device 16 outputs the warning giving the attention to the driver from the speaker 161 as a sound. The warning is not limited to a specific output mode, as long as the warning is a content that gives attention to the driver, for example, that the driving concentration degree is low or that it is necessary to concentrate on the driving. The driver can recognize that the driver is not in the state suitable for the driving of the vehicle 1 by the warning, and concentrate on the driving of the vehicle 1 again. The signal output unit 2318 may output the instruction signal to the support providing device except for the navigation device 13 and the audio output device 16. The signal output unit 2318 may output the instruction signal to the support providing device that gives an external stimulus such as vibration to the driver. The support to the driver is not limited as long as the support is the output content acting on the driver based on the driving concentration degree, and includes various kinds of support to encourage improvement of the driving concentration degree in addition to the warning, call for attention, and information provision.

The signal output unit 2318 can output the instruction signal in the case that at least one driving concentration degree out of the plurality of driving concentration degrees estimated from the plurality of indices does not satisfy the first or second reference. The signal output unit 2318 may output the instruction signal in the case that at least a predetermined number of driving concentration degrees out of the plurality of driving concentration degrees estimated from the plurality of indices does not satisfy the first or second reference.

The signal output unit 2318 may output a switching signal switching the driving mode to the automatic driving control device 14.

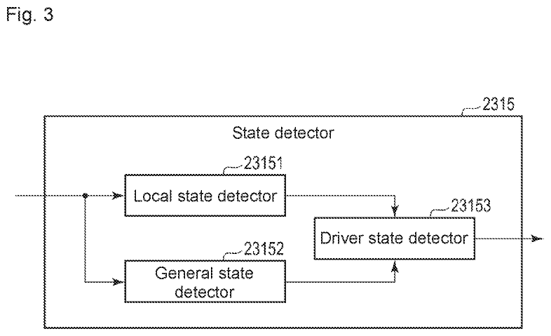

A detection example of the state of the driver using the driver image data by the state detector 2315 will be described below. A method of detecting the state of the driver is not limited to the example described below. FIG. 3 is a block diagram illustrating the configuration of the state detector 2315. For example, the state detector 2315 includes a local state detector 23151, a general state detector 23152, and a driver state detector 23153.

The local state detector 23151 detects the state of at least one of organs included in a face of the driver in the driver image data. Examples of the organs included in the face include eyes, a mouth, a nose, and ears. In the case that the local state detector 23151 detects the state of the eyes, for example, the local state detector 23151 detects a degree of opening and closing of the eyes of the driver, a direction of a line of sight, an orientation of the face, and the like. The local state detector 23151 outputs the detection result (hereinafter, also referred to as local information) to the driver state detector 23153.

The general state detector 23152 detects at least one state out of the general states of the driver in the driver image data. Examples of the general states include the operation and the attitude of the driver. The general state detector 23152 outputs the detection result (hereinafter, also referred to as general information) to the driver state detector 23153.

The driver state detector 23153 detects the state of the driver using the local information from the local state detector 23151 and the general information from the general state detector 23152. In this way, for example, by combining the local information and the general information, the state detector 2315 can detect various states of the driver.

Some detection examples of the object recognition degree by the state detector 2315 will be described below. The state detector 2315 can detect the object recognition degree using the monitoring data and the position information about the object.

By way of example, the state detector 2315 can detect the following object recognition degree by a visual sense of the driver using the external image data in addition to the driver image data. The state detector 2315 extracts the object from the external image data in order to detect the object recognition degree. For example, the object is an installed object such as a sign or a building, but the object is not particularly limited as long as the object has a possibility of being visually recognized by the driver. The state detector 2315 detects the line of sight and the orientation of the face of driver from the driver image data captured at substantially the same timing as the timing of capturing the external image data from which the object is extracted. The line of sight and the orientation of the face of the driver are detected by the local state detector 23151 as described above. The state detector 2315 detects the object recognition degree using at least one of the line of sight and the orientation of the face of the driver and the position information about the object. The object recognition degree increases as the line of sight and the orientation of the face of the driver are directed toward the object.

As another example, using the route information and the current position information in addition to the driver image data, the state detector 2315 can detect the object recognition degree as follows. The state detector 2315 refers to the route information and the current position information, and extracts the object located in the vicinity of the vehicle 1. For example, as described above, the object is an installed object such as a sign or a building, but the object is not particularly limited as long as the object has a possibility of being visually recognized by the driver. The state detector 2315 detects the line of sight and the orientation of the face of the driver from the driver image data captured at substantially the same timing as the timing at which the vehicle 1 passes in the vicinity of the object. The state detector 2315 detects the object recognition degree using at least one of the line of sight and the orientation of the face of the driver and the position information about the object.

As another example, the state detector 2315 may obtain the position of the object and the timing at which the vehicle 1 passes in the vicinity of the object by road-to-vehicle communication. In this case, the state detector 2315 detects the line of sight and the orientation of the face of the driver from the driver image data captured at substantially the same timing as the timing at which the vehicle 1 passes in the vicinity of the object. The state detector 2315 detects the object recognition degree using at least one of the line of sight and the orientation of the face of the driver and the position information about the object.

As another example, the state detector 2315 may use the image or video displayed on the display 131 of the navigation device 13 as the object. In this case, the state detector 2315 detects the line of sight and the orientation of the face of the driver from driver image data captured at substantially the same timing as the timing of displaying the image or video on the display 131. The state detector 2315 detects the object recognition degree using at least one of the line of sight and the orientation of the face of the driver and the position information about the object.

Using at least the monitoring data and the position information about the object as described above, the state detector 2315 can properly detect the state of the driver with the object recognition degree as the index. The state detector 2315 may use the object located in the vicinity of the front, rear, left, or right side of the vehicle 1. Preferably the state detector 2315 uses the object located in the vicinity of the left or right side of the vehicle 1 as compared with the front side of the vehicle 1. The line of sight and the face of the driver do not move so much when the object is located on the front side of the vehicle 1. On the other hand, when the object is located in the vicinity of the left or right side of the vehicle 1, the line of sight and the face of the driver move to the left or right side. Consequently, the state detector 2315 can properly detect the object recognition degree.

(Operation)

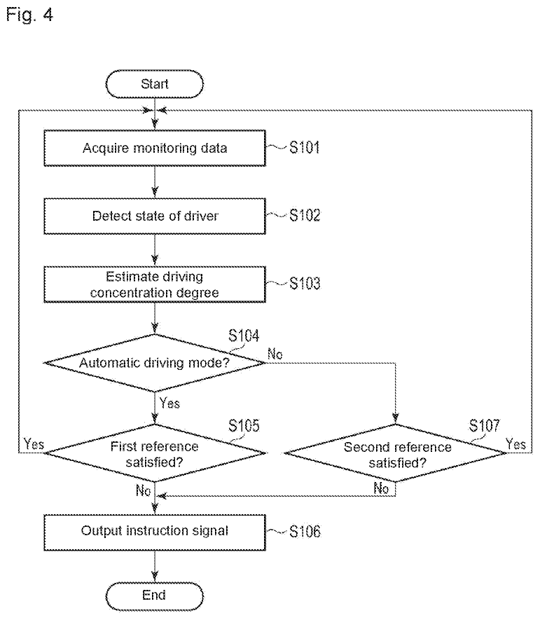

The operation of the concentration degree determination device 2 configured as described above will be described below. FIG. 4 is a flowchart illustrating a procedure as an example of the concentration degree determination made by the concentration degree determination device 2.

The monitoring data acquisition unit 2311 acquires monitoring data from a sensor that monitors the driver of the vehicle 1 (step S101). In step S101, for example, the monitoring data acquisition unit 2311 acquires the driver image data from the driver camera 15 through the input and output interface unit 21. An interval at which the monitoring data acquisition unit 2311 acquires the monitoring data may be equal to or shorter than an interval at which the state detector 2315 detects the state of the driver.

Subsequently, the state detector 2315 detects the state of the driver from the monitoring data (step S102). In step S102, for example, the state detector 2315 detects the state of the driver from the driver image data. For example, the state detector 2315 can detect the state of the driver at predetermined constant intervals. The state detector 2315 may detect the state of the driver at different intervals even if the state of the driver is detected at the same interval between the automatic driving mode and the manual driving mode. The state detector 2315 may detect the state of the driver in any timing.

Subsequently, the concentration degree estimator 2316 estimates the driving concentration degree of the driver from the monitoring data (step S103). In step 103, for example, the concentration degree estimator 2316 estimates the driving concentration degree based on the state of the driver detected from the driver image data by the state detector 2315.

Subsequently, the reference comparator 2317 determines whether the driving mode of the vehicle 1 is the automatic driving mode (step S104). When the driving mode of the vehicle 1 is the automatic driving mode (Yes in step S104), the reference comparator 2317 compares the driving concentration degree to the first reference (step S105). When the driving concentration degree satisfies the first reference (Yes in step S105), the processing of the concentration degree determination device 2 may transition from step S105 to step S101.

When the driving concentration degree does not satisfy the first reference (No in step S105), the signal output unit 2318 outputs the instruction signal instructing the performance of the support to the driver (step S106). That is, in step S106, when the driving mode is the automatic driving mode, and when the driving concentration degree does not satisfy the first reference, the signal output unit 2318 outputs the instruction signal.

When the driving mode is not the automatic driving mode (No in step S104), the reference comparator 2317 compares the driving concentration degree to the second reference different from the first reference (step S107). The case that the driving mode is not the automatic driving mode corresponds to the case that the driving mode is the manual driving mode. When the driving concentration degree satisfies the second reference (Yes in step S107), the processing of the concentration degree determination device 2 may transition from step S107 to step S101.

When the driving concentration degree does not satisfy the second reference (No in step S107), the signal output unit 2318 outputs the instruction signal (step S106). That is, in step S106, when the driving mode is the manual driving mode, and when the driving concentration degree does not satisfy the second reference, the signal output unit 2318 outputs the instruction signal.

The index with which the concentration degree estimator 2316 estimates the driving concentration degree in step S103 is not particularly limited, but the concentration degree estimator 2316 may estimate the driving concentration degree with the looking aside of the driver as an index. The looking aside is an index that have a large influence on the driving safety. The concentration degree determination device 2 can monitor whether the driver is in the state suitable for the driving using the index having the large influence on the driving safety regardless of the driving mode. Consequently, the driver can maintain the state of further concentrating on the driving regardless of the driving mode.

A relationship between the first reference and the second reference used by the reference comparator 2317 in steps S105 and S107 may be such a relationship that the second reference becomes a reference in which the driving concentration degree higher than the first reference is required for the driver (hereinafter, referred to as a first relationship).

In this example, in step S105, the reference comparator 2317 compares the driving concentration degree estimated by the concentration degree estimator 2316 to the first reference value or the first reference level, which becomes the first reference. When the driving concentration degree is greater than or equal to the first reference value or the first reference level, the reference comparator 2317 determines that the driving concentration degree satisfies the first reference. On the other hand, when the driving concentration degree is lower than the first reference value or the first reference level, the reference comparator 2317 determines that the driving concentration degree does not satisfy the first reference.

In this example, in step S107, the reference comparator 2317 compares the driving concentration degree estimated by the concentration degree estimator 2316 to the second reference value or the second reference level, which becomes the second reference. When the driving concentration degree is greater than or equal to the second reference value or the second reference level, the reference comparator 2317 determines that the driving concentration degree satisfies the second reference. On the other hand, when the driving concentration degree is lower than the second reference value or the second reference level, the reference comparator 2317 determines that the driving concentration degree does not satisfy the second reference.

In this example, in the case of the manual driving mode, the concentration degree determination device 2 can require the driver to secure the driving concentration degree higher than that of the automatic driving mode. Consequently, in the case of the manual driving mode, the driver can maintain the state of further concentrating on the driving as compared with the case of the automatic driving mode. Additionally, the driver does not receive an excessive warning, particularly in the automatic driving mode.

A relationship between the first reference and the second reference used by the reference comparator 2317 in steps S105 and S107 may be such a relationship that the second reference becomes a reference in which the predetermined driving concentration degree is required for the driver in timing different from the first reference (hereinafter, referred to as a second relationship). The concentration degree determination device 2 varies the timing of determining the driving concentration degree as follows between the first reference applied to the automatic driving mode and the second reference applied to the manual driving mode. That is, in the manual driving mode, the concentration degree determination device 2 may determine the driving concentration degree at a higher frequency than that of the automatic driving mode. For example, the first reference may be configured to determine the driving concentration degree at predetermined time intervals or predetermined running distance intervals. On the other hand, the second reference may be configured to always determine the driving concentration degree. Alternatively, in the case that the concentration degree determination device 2 determines the driving concentration degree according to the running scene, the concentration degree determination device 2 may vary the running scene in which the driving concentration degree is determined in the automatic driving mode and the manual driving mode. For example, the first reference may be configured to determine the driving concentration degree on condition that a specific running scene has a relatively large variation of the vehicle surrounding environment. On the other hand, the second reference may be configured to always determine the driving concentration degree regardless of the running scene. Examples of the running scenes include a vicinity of an intersection, a vicinity of an entrance and exit of an expressway, and the case that an attention object such as a pedestrian is detected.

In this example, in step S105, the reference comparator 2317 may compare the driving concentration degree estimated by the concentration degree estimator 2316 to the reference value or the reference level in timing that becomes the first reference. When the driving concentration degree is greater than or equal to the reference value or the reference level, the reference comparator 2317 determines that the driving concentration degree satisfies the first reference. On the other hand, when the driving concentration degree is lower than the reference value or the reference level, the reference comparator 2317 determines that the driving concentration degree does not satisfy the first reference.

In this example, in step S107, the reference comparator 2317 may compare the driving concentration degree estimated by the concentration degree estimator 2316 to the reference value or the reference level in timing that becomes the second reference. When the driving concentration degree is greater than or equal to the reference value or the reference level, the reference comparator 2317 determines that the driving concentration degree satisfies the second reference. On the other hand, when the driving concentration degree is lower than the reference value or the reference level, the reference comparator 2317 determines that the driving concentration degree does not satisfy the second reference.

In this example, the concentration degree determination device 2 can determine the driving concentration degree in proper timing corresponding to the driving mode. The concentration degree determination device 2 does not output the instruction signal in timing at which the determination of the driving concentration degree can be omitted. Consequently, the driver can maintain the state of concentrating on the driving according to the driving mode. Additionally, the driver does not receive an excessive warning, particularly in the automatic driving mode.

A relationship between the first reference and the second reference used by the reference comparator 2317 in steps S105 and S107 may be such a relationship that the second reference becomes a reference in which the continuation of the predetermined driving concentration degree is required for the driver over a period longer than the first reference (hereinafter, referred to as a third relationship). In this example, the concentration degree determination device 2 determines the driving concentration degree on condition that the driving concentration degree greater than or equal to the reference value or the reference level continues for a predetermined period. The concentration degree determination device 2 varies the predetermined period between the first reference applied to the automatic driving mode and the second reference applied to the manual driving mode. That is, the second reference may lengthen the predetermined period as compared with the first reference.

In this example, in step S105, the reference comparator 2317 determines whether the driving concentration degree estimated by the concentration degree estimator 2316 is continuously greater than or equal to the reference value or the reference level for a first predetermined period. When the driving concentration degree is continuously greater than or equal to the reference value or the reference level for the first predetermined period, the reference comparator 2317 determines that the driving concentration degree satisfies the first reference. On the other hand, when the driving concentration degree is lower than the reference value or the reference level in the first predetermined period, the reference comparator 2317 determines that the driving concentration degree does not satisfy the first reference.

In this example, in step S107, the reference comparator 2317 determines whether the driving concentration degree estimated by the concentration degree estimator 2316 is continuously greater than or equal to the reference value or the reference level for a second predetermined period different from the first predetermined period. When the driving concentration degree is continuously greater than or equal to the reference value or the reference level for the second predetermined period, the reference comparator 2317 determines that the driving concentration degree satisfies the second reference. On the other hand, when the driving concentration degree is lower than the reference value or the reference level in the second predetermined period, the reference comparator 2317 determines that the driving concentration degree does not satisfy the second reference.

In this example, in the case of the manual driving mode, the concentration degree determination device 2 can require the driver to continuously secure the predetermined driving concentration degree longer than that of the automatic driving mode. Consequently, in the case of the manual driving mode, the driver can maintain the state of further concentrating on the driving as compared with the case of the automatic driving mode. Additionally, the driver does not receive an excessive warning, particularly in the automatic driving mode.

A relationship between the first reference and the second reference used by the reference comparator 2317 in steps S105 and S107 may be such a relationship that at least two of the first relationship, the second relationship, and the third relationship are properly combined. For example, the combination of the first relationship and the second relationship is as follows. The second reference may be such a reference that the driving concentration degree higher than the first reference is required for the driver in timing different from the first reference. For example, the combination of the first relationship and the third relationship is as follows. The second reference may be such a reference that the continuation of the driving concentration degree higher than the first reference is required for the driver over a period longer than the first reference. For example, the combination of the second relationship and the third relationship is as follows. The second reference may be such a reference that the predetermined driving concentration degree is required for the driver over the period longer than the first reference in timing different from the first reference. For example, the combination of the first relationship, the second relationship, and the third relationship is as follows. The second reference may be such a reference that the driving concentration degree higher than the first reference is required for the driver over the period longer than the first reference in timing different from the first reference.

(Effect)

As described above in detail, in one embodiment of the present invention, the concentration degree determination device 2 determines whether the driver is in the state suitable for the driving by selectively using the first reference and the second reference according to the automatic driving mode or the manual driving mode. For this reason, the concentration degree determination device 2 can require the driver to secure the driving concentration degree suitable for each of the automatic driving mode and the manual driving mode. Consequently, the driver can maintain the state of concentrating on the driving regardless of the driving mode. For example, the driver can maintain the state of concentrating on the driving in the manual driving mode, and the driver does not manually drive the vehicle but can maintain the state of preparing an unexpected situation in the automatic driving mode. Thus, the driving safety is maintained regardless of the situation in which the driver is placed.

Even if the state of the driver is the same between the manual driving mode and the automatic driving mode, the concentration degree determination device 2 outputs the instruction signal in the manual driving mode, but the concentration degree determination device 2 does not output the instruction signal in the automatic driving mode. For this reason, the concentration degree determination device 2 can reduce the output of the excessive instruction signal in the automatic driving mode. Consequently, the driver does not receive the excessive warning particularly in the automatic driving mode, so that the driver can comfortably maintain the state of concentrating on the driving regardless of the driving mode. Thus, the driving comfort is maintained regardless of the situation in which the driver is placed.

As described above, the concentration degree determination device 2 can consider both the driving safety and the driving comfort.

(Other embodiments)

In the embodiment, the concentration degree determination device 2 detects the state of the driver using the driver image data captured by the driver camera 15 as monitoring data, and estimates the driving concentration degree. However, the monitoring data is not limited to the driver image data. For example, the monitoring data may be biological data obtained by a biosensor that monitors the driver of the vehicle 1. For example, the biosensor is a pulse wave sensor or a heart beat sensor. The biosensor is not limited to the pulse wave sensor or the heart beat sensor as long as biosensor can monitor the driver. The biosensor may be a contact type sensor or a non-contact type sensor. The concentration degree determination device 2 can detect the state of the driver from the biological data. For example, the state of the driver detected from the biological data is an index such as a pulse wave or a heart beat. For example, the monitoring data may be data obtained by a sensor that is installed in the steering wheel 5 to measure strength of the driver who grasps the steering wheel 5.

In short, the present invention is not limited to the above embodiment, and constituent elements can be modified and embodied in the implementation stage without departing from the gist thereof. Various inventions can be made by appropriately combining a plurality of constituent elements disclosed in the above embodiment. For example, some constituent elements may be deleted from all the constituent elements illustrated in the embodiment. Constituent elements over different embodiments may appropriately be combined.

The embodiment may be implemented by a storage medium such as a read only memory (ROM) that stores a program causing the processor 231 to execute processing of each unit included in the processor 231.

A part or all of the above embodiment may also be described as follows, but is not limited to the following.

### (Supplementary Note 1)

A concentration degree determination device including: a processor configured to acquire monitoring data from a sensor that monitors a driver of a vehicle,

to estimate a driving concentration degree of the driver from the monitoring data.

to compare the driving concentration degree to a first reference when a driving mode of the vehicle is an automatic driving mode, and to compare the driving concentration degree to a second reference different from the first reference when the driving mode is a manual driving mode, and

to output an instruction signal instructing performance of support to the driver when the driving mode is the automatic driving mode while the driving concentration degree does not satisfy the first reference, or when the driving mode is the manual driving mode while the driving concentration degree does not satisfy the second reference; and

a memory that stores an instruction to operate the processor.

### (Supplementary Note 2)

A concentration degree determination method including:

a monitoring data acquisition step of acquiring monitoring data from a sensor that monitors a driver of a vehicle using at least one processor;

a concentration degree estimating step of estimating a driving concentration degree of the driver from the monitoring data using the at least one processor;

a reference comparing step of comparing the driving concentration degree to a first reference when a driving mode of the vehicle is an automatic driving mode using the at least one processor, and of comparing the driving concentration degree to a second reference different from the first reference when the driving mode is a manual driving mode using the at least one processor; and

a signal output step of outputting an instruction signal instructing performance of support to the driver using the at least one processor when the driving mode is the automatic driving mode while the driving concentration degree does not satisfy the first reference, or when the driving mode is the manual driving mode while the driving concentration degree does not satisfy the second reference.

1. A concentration degree determination device comprising:
a processor configured with a program to perform operations comprising:
operation as a monitoring data acquisition unit configured to acquire monitoring data from a sensor that monitors a driver of a vehicle;
operation as a concentration degree estimator configured to estimate a driving concentration degree of the driver from the monitoring data;
operation as a reference comparator configured to compare the driving concentration degree to a first reference in response to a driving mode of the vehicle being an automatic driving mode, the first reference being used to determine the driving concentration degree on a condition of a specific running scene, and to compare the driving concentration degree to a second reference in response to the driving mode being a manual driving mode, a predetermined driving concentration degree being required for the driver in a running scene different from the running scene in the first reference; and
operation as a signal output unit configured to output an instruction signal instructing performance of support to the driver in response to the driving mode being the automatic driving mode while the driving concentration degree does not satisfy the first reference, or in response to the driving mode being the manual driving mode while the driving concentration degree does not satisfy the second reference.

2. The concentration degree determination device according to claim 1, wherein the second reference is such a reference that the driving concentration degree higher than the first reference is required for the driver.

3. (canceled)

4. The concentration degree determination device according to claim 1, wherein the second reference is such a reference that continuation of a predetermined driving concentration degree is required for the driver over a period longer than the first reference.

5. The concentration degree determination device according to claim 1, wherein the processor is configured with the program perform operations such that operation as the concentration degree estimator is further configured to estimate the driving concentration degree with looking aside of the driver as an index.

6. A concentration degree determination method comprising:
acquiring monitoring data from a sensor that monitors a driver of a vehicle;
a estimating a driving concentration degree of the driver from the monitoring data;
comparing the driving concentration degree to a first reference in response to a driving mode of the vehicle being an automatic driving mode, the first reference being used to determine the driving concentration degree on a condition of a specific running scene, and of comparing the driving concentration degree to a second reference in response to the driving mode being a manual driving mode, a predetermined driving concentration degree being required for the driver in a running scene different from the running scene in the first reference; and
outputting an instruction signal instructing performance of support to the driver in response to the driving mode being the automatic driving mode while the driving concentration degree does not satisfy the first reference, or in response to the driving mode being the manual driving mode while the driving concentration degree does not satisfy the second reference.

7. A non-transitory computer-readable storage medium storing a program for determining concentration degree, the program, which when read and executed, causes a computer to perform the operations comprised in the concentration degree determination device according to claim 1.

8. The concentration degree determination device according to claim 2, wherein the processor is configured with the program perform operations such that operation as the concentration degree estimator is further configured to estimate the driving concentration degree with looking aside of the driver as an index.

9. The concentration degree determination device according to claim 4, wherein the processor is configured with the program perform operations such that operation as the concentration degree estimator is further configured to estimate the driving concentration degree with looking aside of the driver as an index.

10. A non-transitory computer-readable storage medium storing a program for determining concentration degree, the program, which when read and executed, causes a computer to perform the operations comprised in the concentration degree determination device according to claim 2.

11. A non-transitory computer-readable storage medium storing a program for determining concentration degree, the program, which when read and executed, causes a computer to perform the operations comprised in the concentration degree determination device according to claim 4.

12. A non-transitory computer-readable storage medium storing a program for determining concentration degree, the program, which when read and executed, causes a computer to perform the operations comprised in the concentration degree determination device according to claim 5.

13. A non-transitory computer-readable storage medium storing a program for determining concentration degree, the program, which when read and executed, causes a computer to perform the operations comprised in the concentration degree determination device according to claim 8.

14. A non-transitory computer-readable storage medium storing a program for determining concentration degree, the program, which when read and executed, causes a computer to perform the operations comprised in the concentration degree determination device according to claim 9.
